(19) United States
(12) Patent Application Publication
(10) Pub. No.: US 2003/0015383 A1
(43) Pub. Date: Jan. 23, 2003

(54) WHEELED LUGGAGE

(76) Inventor: James Tsai, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/906,793

(22) Filed: Jul. 18, 2001

(51) Int. Cl. E05B 1/00; E05B 7/00; A47B 95/02; A45C 13/30

(52) U.S. Cl. 190/115; 16/113.1; 190/18 A

(57) ABSTRACT

A wheeled luggage comprises: A soft bag, having a bottom side wall, a top side wall, a first side wall, a second side wall and two lateral side walls. A frame body, comprising a base frame and a supporting frame. The frame body fixed on the bag by the base frame of the frame body fixing on the bottom side wall of the bag and the supporting frame of the frame body fixing on the first side wall of the bag. Two carrying belt, provided on the second side wall of the bag. Two wheels pivoted at the bottom side of the frame body for free rotating. A retractable assembly, having one end provided at the supporting frame of the frame body for extending and collapsing, and a handle provided at the outer end of the retractable assembly.

### FIELD OF THE INVENTION

The present invention relates to a luggage case and, more particularly, to a wheeled luggage.

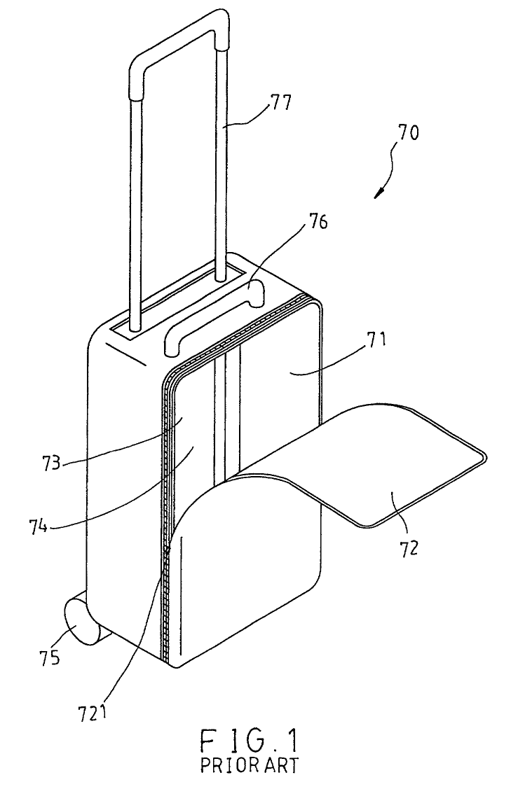

FIG. 1 shows a conventional wheeled luggage, which comprises a rectangular frame body 70, which supports the luggage in shape, a flexible fabric covering covered on the frame body 71 to form side walls 72 and 73 of the luggage. The flexible fabric covering defines a storage space 74 for holding goods, clothes, and etc. One outside wall 72 has a zipper 721, which controls the entrance of the storage space 73. The luggage comprises two wheel assemblies 75 at the bottom side, a handle 76 at the center of the top side, and a retractable handle 77 near the rear side.

The inventor finds the structure of wheeled luggage disclosed above having some disadvantages:

1. When the user carrying the luggage, the front side wall 72 is a soft cloth. So that the goods stored in the storage space 73 are easy to be damaged by unexpected force.

2. The retractable handle 75 located at the rear side wall 73 of the luggage, when the user carrying the luggage by hand or carrying it on back. The rigid retractable handle 75 will be against on human body and make the user uncomfortable.

3. The frame body 71 made the luggage 70 can't adjust the size of the storage space 74. Although there were some solutions to adjust the size of the storage space of a luggage in prior art. But the disclosed adjusting mechanism is complex and not easy to operate.

### SUMMARY OF THE INVENTION

The primary objective of the present invention is to provide a wheeled luggage, which is free from the drawbacks described above.

In keeping with the principle of the present invention, the wheeled luggage of the present invention comprises: A bag, having a bottom side wall, a top side wall, a first side wall, a second side wall and two lateral side walls. A frame body, comprising a base frame and a supporting frame. The frame body fixed on the bag by the base frame of the frame body fixing on the bottom side wall of the bag and the supporting frame of the frame body fixing on the first side wall of the bag. Two wheels pivoted at the bottom side of the frame body for free rotating. A retractable assembly, having one end provided at the supporting frame of the frame body for extending and collapsing, and a handle provided at the outer end of the retractable assembly.

### BRIEF DESCRIPTION OF THE INVENTION

FIG. 1 shows the structure of the wheeled luggage of prior art.

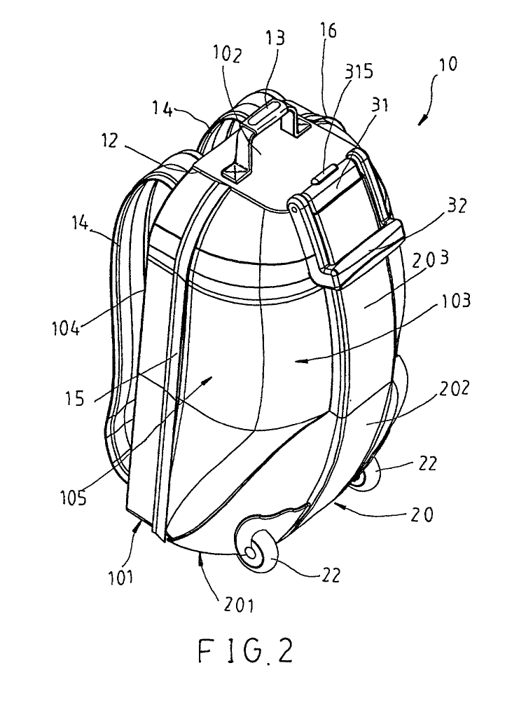

FIG. 2 shows a perspective view of the embodiment of the present invention, in which the retractable handle positioned at the collapsed position.

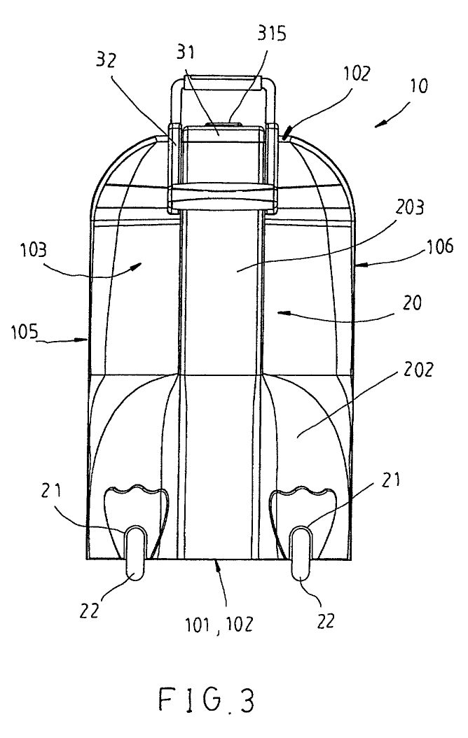

FIG. 3 shows a front view of he embodiment of the present invention.

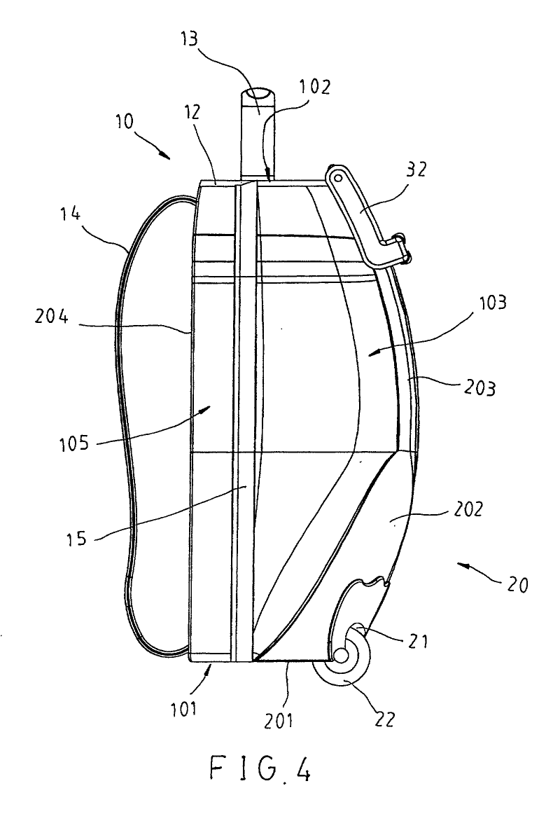

FIG. 4 shows a side view of he embodiment of the present invention.

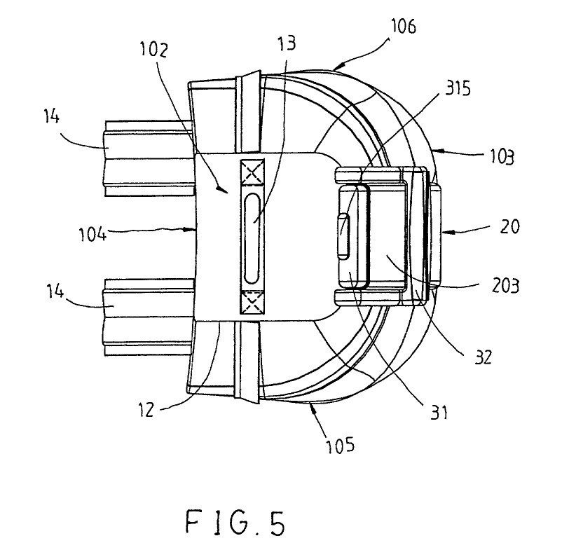

FIG. 5 shows a top view of he embodiment of the present invention.

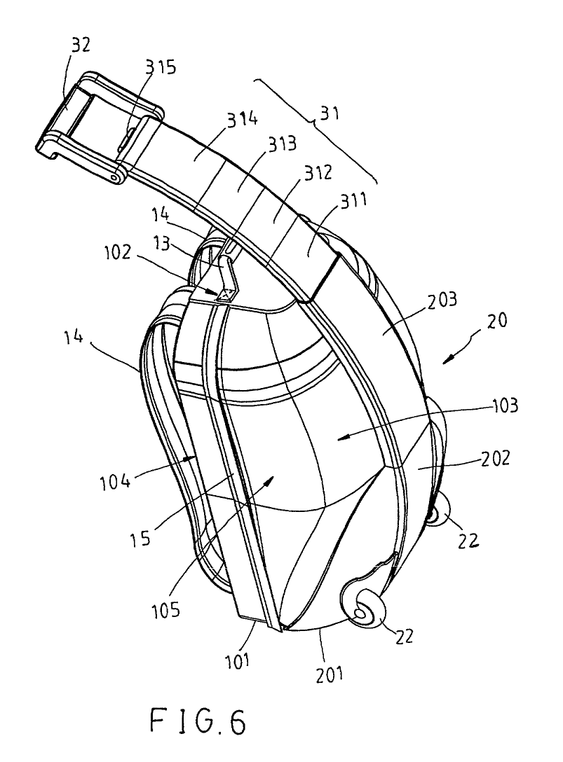

FIG. 6 shows a perspective view of the embodiment of the present invention, in which the retractable handle positioned at the extended position.

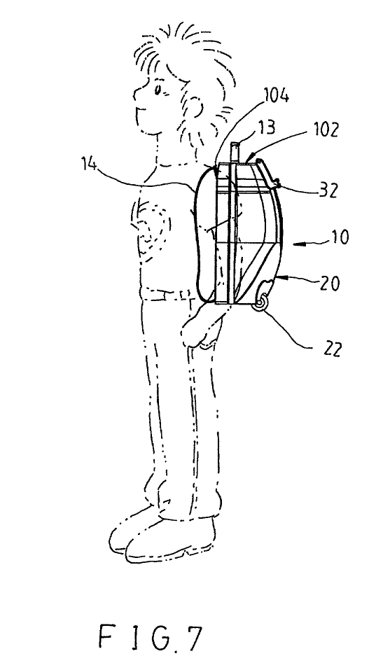

FIG. 7 is a schematic view showing the user carrying the wheeled luggage of the present invention on back.

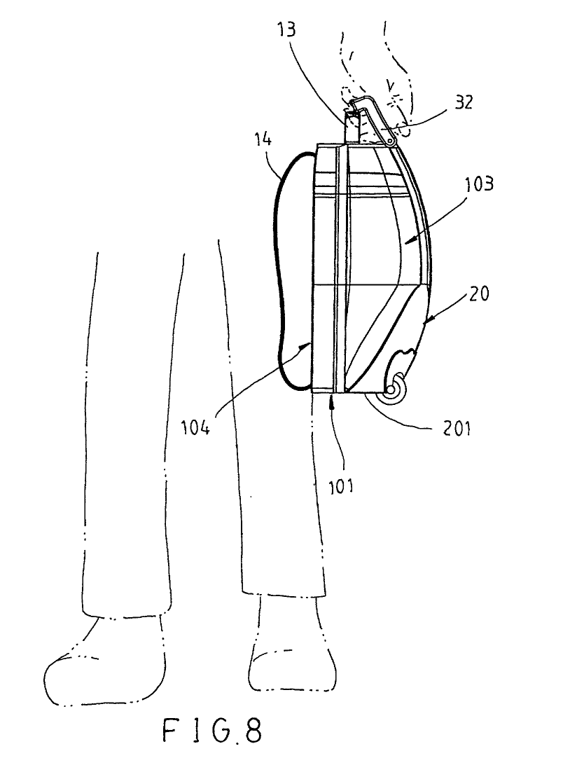

FIG. 8 is a schematic view showing the user carrying the wheeled luggage of the present invention by hand.

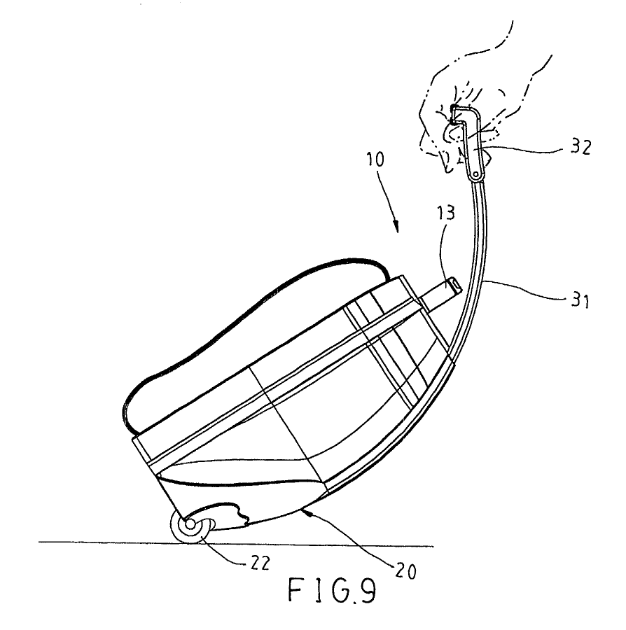

FIG. 9 is a schematic view showing the user pulling the wheeled luggage of the present invention to move on the ground.

### DETAIL DESCRIPTION OF THE INVENTION

Please refer to FIG. 2 to FIG. 6, the wheeled luggage of the embodiment of the present invention comprises:

A soft bag 10, which has a bottom side wall 101, a top side wall 102, a first side wall 103, a second side wall 104 and two lateral side walls 105 and 106. The bottom and top side wall 101 and 102 are defined as the bottom side and top side of the bag 10. The first and second side wall 103 and 104 are defined as the front side and rear side of the bag 10, and the lateral side walls 105 and 106 are the left and right side of the bag 10. The top side wall 102 fixed with the second side wall 104, and connected to the first and the two lateral side walls 103, 105 and 106 with a zipper 12 to be the entrance of storing goods in the bag 10. The top side wall 102 also provides a bag handle 13 for user to grip. Two carrying belts 14 provided on the second side wall 104 for user to carry on back. Two elongated elastic pieces 15 and 16 respectively disposed on the lateral side walls 105 and 106 to provide the lateral side walls 105 and 106 a capacity of expanding the width thereof.

A frame body 20, which is made of a hard plastic plank with substantially a L shape in the cross side view. Wherein, the horizontal part of the frame body 10 is defined as a base frame 201, and the vertical part of the frame body 10 is defined as a supporting frame 202. The supporting frame 202 has an elongated handle seat 203 at the top end thereof. Two wheeled slots 21 disposed parallel on the flexure portion of the frame body 20 with two wheels 22 pivoted thereof respectively for free rotating.

The frame body 20 stitched on the bag 10 by the base frame 201 fixing on the bottom side wall 101 and the supporting frame 202 fixing on the first side wall 103. At this time, the outer end of the handle seat 203 be closing to the top end of the first side wall 103 of the bag 10. So that, the bag 10 will be supported by the frame body 20 in a predetermined shape. It has to be mention here, that the way of the frame body 20 fixed on the bag 10 also can be done by coherence, rivets or screws etc. A retractable assembly 31, please refer to FIG. 6, which has four segments 311, 312, 313 and 314. One of the segments 314 received in the handle seat 203 of the frame body 20, the other segments 311, 312 and 313 are installed in sequent. The segments 311, 312, 313 and 314 are arced, flat tubes with different sizes, so that the retractable assembly 31 will be an arced elongated tube when extending (as shown in FIG. 6), or collapsing to receive in the handle seat 203 (as shown in FIG. 2). And there was a control mechanism (not shown in figure) in the retractable assembly 31 for controlling the segments 311, 312, 313 and 314 to extend or collapse. The control mechanism is disclosed in a conventional retractable handle, please refer that for detail.

The retractable assembly 31 might be made of an elastic material, like mental piece, carbon fiber or glass fiber of the composite material. The elastic material is made into an elongated strip and received in the handle seat 203 of the frame body 20. That would provide the same function for the embodiment of the present invention.

A handle 32 pivoted at the outer segment 311 of the retractable assembly 31. Inside the handle 32 has a spring (not shown) to provide the handle has an initial (collapsed) position of orientated downward shown in FIG. 2. The handle 32 can be turned by user to an operating position as shown in FIG. 8, in which the outer end of the handle 32 against on the bag handle 13 for user to grip both of the handle 32 and the bag handle 13 to carry the wheeled luggage of the present invention.

The wheeled luggage of the present invention has the advantages hereunder:

1. When user carry the wheeled luggage of the present invention, the supporting frame 202 of the frame body 20 located at the front side of the wheeled luggage. The rigid supporting frame 202 will protect the goods stored in the bag 10 from damaged by unexpected force.

2. User can carry the wheeled luggage of the present invention on back (as shown in FIG. 7), carry it by hand (as shown in FIG. 8) or pull it to move on the ground (as shown in FIG. 9). When the user carrying the wheeled luggage of the present invention on back or by hand, the second side wall 104 of the bag 10 is the surface being against the user. The softy second side wall 104 will provide the user more comfortable.

3. When user put too many goods in the bag 10, the elastic pieces 15 and 16 on the lateral side wall 105 and 106 will be expended to increase the widths of the lateral side wall 105 and 106 according to the sizes of the goods. The lateral side wall 105 and 106 will return to the original widths when taking some goods away. Which means the wheeled luggage of the present invention can provide a function of automatic adjusting the size of the bag 10.

What is claimed is:

1. A wheeled luggage comprises:
a soft bag, having a bottom side wall, a top side wall, a first side wall, a second side wall and two lateral side walls;
a frame body, comprising a base frame and a supporting frame; said frame body fixed on said bag by said base frame of said frame body fixing on said bottom side wall of said bag and said supporting frame of said frame body fixing on said first side wall of said bag;
two wheels pivoted at the bottom side of said frame body for free rotating;
a retractable assembly, having one end provided at said supporting frame of said frame body for extending and collapsing; and
a handle provided at the outer end of said retractable assembly.

2. The wheeled luggage as defined in claim 1, wherein said base frame of said frame body is substantially a plank; said supporting frame of said frame body is substantially a plank too, which has one end connected with said base frame in a predetermined angle.

3. The wheeled luggage as defined in claim 1, wherein said frame body further has a handle seat connected with said supporting frame; said handle seat fixed on said first side wall of said bag; said retractable assembly installed in said handle seat.

4. The wheeled luggage as defined in claim 1, wherein further comprising at least one carrying belt provided on the second side wall of said bag.

5. The wheeled luggage as defined in claim 1, wherein further comprising two elastic pieces provided on said lateral side walls of said bag respectively.

6. The wheeled luggage as defined in claim 1, wherein further comprising a bag handle provided on said top side wall of said bag.

7. The wheeled luggage as defined in claim 1 wherein said frame body has two parallel wheel slots at the bottom side thereof, said wheels received in said wheel slots respectively.

8. The wheeled luggage as defined in claim 1, wherein said bag has at least one zipper thereof for opening and closing said bag.

9. The wheeled luggage as defined in claim 1, wherein said handle pivoted at said retractable assembly for turning downwards to a collapsed position and turning upwards to an operating position.

10. The wheeled luggage as defined in claim 9, wherein further comprising a spring provided at said handle to keep the collapsed position as the initial position of said handle.

11. The wheeled luggage as defined in claim 10, wherein said bag further has a bag handle on said top side wall thereof, said handle is against said bag handle when turning to the operating position.

12. The wheeled luggage as defined in claim 1, wherein said retractable assembly is arced when expending.

13. The wheeled luggage as defined in claim 12, wherein said retractable assembly comprises plurality of arced segments.

14. The wheeled luggage as defined in claim 12, wherein said retractable assembly is a elastic elongated strip.

15. A wheeled luggage comprises:
a soft bag, having a bottom side wall, a top side wall, a first side wall, a second side wall and two lateral side walls;
a frame body, comprising a base frame and a supporting frame; said frame body fixed on said bag by said base frame of said frame body fixing on said bottom side wall of said bag and said supporting frame of said frame body fixing on said first side wall of said bag;
at least on carrying belt, provided on said second side wall of said bag.
two wheels pivoted at the bottom side of said frame body for free rotating;
a retractable assembly, having one end provided at said supporting frame of said frame body for extending and collapsing; and
a handle provided at the outer end of said retractable assembly.

16. The wheeled luggage as defined in claim 15, wherein said base frame of said frame body is substantially a plank; said supporting frame of said frame body is substantially a plank too, which has one end connected with said base frame in a predetermined angle.

17. The wheeled luggage as defined in claim 15, wherein said frame body further has a handle seat connected with said supporting frame; said handle seat fixed on said first side wall of said bag; said retractable assembly installed in said handle seat.

18. The wheeled luggage as defined in claim 15, wherein further comprising two elastic pieces, provided on said lateral side walls of said bag respectively.
